(19) United States
(12) Patent Application Publication
(10) Pub. No.: US 2016/0295026 A1
(43) Pub. Date: Oct. 6, 2016

(54) METHOD AND SYSTEM FOR MOBILE APPLICATION USAGE AND SPONSORED ROAMING

(71) Applicant: MasterCard International Incorporated, Purchase, NY (US)

(72) Inventors: Ciaran Brian McMULLAN, Dublin (IE); John Robert FORREST, Dublin (IE)

(73) Assignee: MasterCard International Incorporated, Purchase, NY (US)

(21) Appl. No.: 14/672,806

(22) Filed: Mar. 30, 2015

(51) Int. Cl. H04M 15/00; H04W 4/24; H04W 4/02

(52) U.S. Cl. CPC H04M 15/8038; H04W 4/021; H04W 4/24

(57) ABSTRACT

A method for providing sponsored roaming for a mobile device includes: receiving a data usage request, the data usage request being received from a mobile computing device associated with a first mobile network operator, originating from a geographic location associated with a second mobile network operator, and including at least a device identifier associated with the mobile computing device and a merchant identifier associated with a merchant; transmitting a data request to an entity associated with control of data usage by the mobile computing device, the data request including the device identifier; identifying a transaction amount based on at least a data amount transmitted as a result of the received data usage request; and initiating a payment transaction for payment of a roaming charge associated with the transmitted data by the merchant associated with the merchant identifier, wherein the payment transaction is for payment of the identified transaction amount.

### FIELD

The present disclosure relates to sponsored roaming on mobile devices, specifically the payment of roaming charges on a mobile device by a merchant receiving benefit of roaming on the mobile device instead of the user of the mobile device.

### BACKGROUND

In recent times, people have become more and more reliant on their mobile devices for activities ranging from shopping to traveling to working and more. Traditionally, a mobile device is associated with a network operator for connection to a cellular network or other type of communication network that can provide the mobile device with access to the Internet, telephone networks, or other forms of communication. As long as the mobile device is in a location where there is coverage by their network operator, the mobile device can access the associated networks and communicate accordingly. However, once a user and their mobile device travel to an area that does not have coverage by their mobile network operator, they may find themselves without network access.

Traditionally, when a user and their device leave the coverage area of their network operator, the user may be able to access a different network with their mobile device, operated by a second mobile network operator that has coverage in the area where the user has traveled. The access of a different network is often referred to as “roaming.” When a device is roaming in a second network, the second network must accommodate for the additional traffic caused by the device. The resources provided by the second network, such as data usage, can come at a significant expense to the second network. In order to provide an incentive for the second network to provide service to roaming mobile devices, in traditional systems mobile network operators will often charge the home mobile network operator fees associated with the data used by the roaming mobile devices. In order to recover costs, many mobile network operators will charge the accounts associated with the roaming mobile devices, for which there are already protocols and communications in place.

However, this can often discourage users, who may neglect usage of their mobile device when roaming because of the associated costs. At the same time, many entities may benefit if a user utilizes their mobile device when roaming, such as their home mobile network operator that gets an increase in consumer goodwill for ensuring service even when outside of their coverage area, the roaming mobile network operator for providing the service outside of the home area, the user that can enjoy network access even when traveling to outside of their home coverage area, and any entity the user interacts with during roaming, such as a merchant with whom the user transacts. The merchant may be able to conduct transactions with a user that is roaming, if the user's mobile device has service in the roaming area, which the merchant may miss out on if the user is unable, or unwilling, to use their mobile device in a roaming area. Thus, merchants and other third party entities may have a desire to sponsor roaming on a mobile device.

Unfortunately, existing mobile communication systems lack the communication protocols and technology to provide for sponsored roaming for mobile devices. Existing systems often lack the communication protocols and standards to receive detailed information from mobile devices regarding usage, such as to identify an entity that may sponsor roaming based on data usage by the mobile device. Existing systems may also be unable to communicate with third party entities both due to lack of communication paths between the mobile communication system and the entities, but also because existing mobile communication systems may lack the programming and capability to communicate using protocols and standards utilized by the entities. As a result, existing systems suffer from a number of technical limitations. Accordingly, there is a need for a technical solution to provide for sponsored roaming of mobile devices achievable using the methods and systems discussed herein.

### SUMMARY

The present disclosure provides a description of systems and methods for providing sponsored roaming for a mobile device.

A method for providing sponsored roaming for a mobile device includes: receiving, by a receiving device, a data usage request, wherein the data usage request is received from a mobile computing device associated with a first mobile network operator, originates from a geographic location associated with a second mobile network operator, and includes at least a device identifier associated with the mobile computing device and a merchant identifier associated with a merchant; transmitting, by a transmitting device, a data request to an entity associated with control of data usage by the mobile computing device, wherein the data request includes at least the device identifier; identifying, by a processing device, a transaction amount based on at least a data amount transmitted as a result of the received data usage request; and initiating, by the processing device, a payment transaction for payment of a roaming charge associated with the transmitted data by the merchant associated with the merchant identifier, wherein the payment transaction is for payment of the identified transaction amount.

A system for providing sponsored roaming for a mobile device includes a receiving device, a transmitting device, and a processing device. The receiving device is configured to receive a data usage request, wherein the data usage request is received from a mobile computing device associated with a first mobile network operator, originates from a geographic location associated with a second mobile network operator, and includes at least a device identifier associated with the mobile computing device and a merchant identifier associated with a merchant. The transmitting device is configured to transmit a data request to an entity associated with control of data usage by the mobile computing device, wherein the data request includes at least the device identifier. The processing device is configured to: identify a transaction amount based on at least a data amount transmitted as a result of the received data usage request; and initiate a payment transaction for payment of a roaming charge associated with the transmitted data by the merchant associated with the merchant identifier, wherein the payment transaction is for payment of the identified transaction amount.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for providing sponsored roaming for a mobile device in accordance with exemplary embodiments.

FIG. 2 is a block diagram illustrating the processing server of FIG. 1 for providing sponsored roaming for a mobile device in accordance with exemplary embodiments.

FIG. 3 is a flow diagram illustrating a process for providing sponsored roaming for a mobile device using the system of FIG. 1 in accordance with exemplary embodiments.

FIG. 4 is a flow diagram illustrating a process for providing sponsored roaming for a mobile device using the processing server of FIG. 2 in accordance with exemplary embodiments.

FIG. 5 is a diagram illustrating a graphical user interface of a mobile device for obtaining sponsored roaming in accordance with exemplary embodiments.

FIG. 6 is a flow chart illustrating an exemplary method for providing sponsored roaming for a mobile device in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network−A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Providing Sponsored Roaming for a Mobile Device

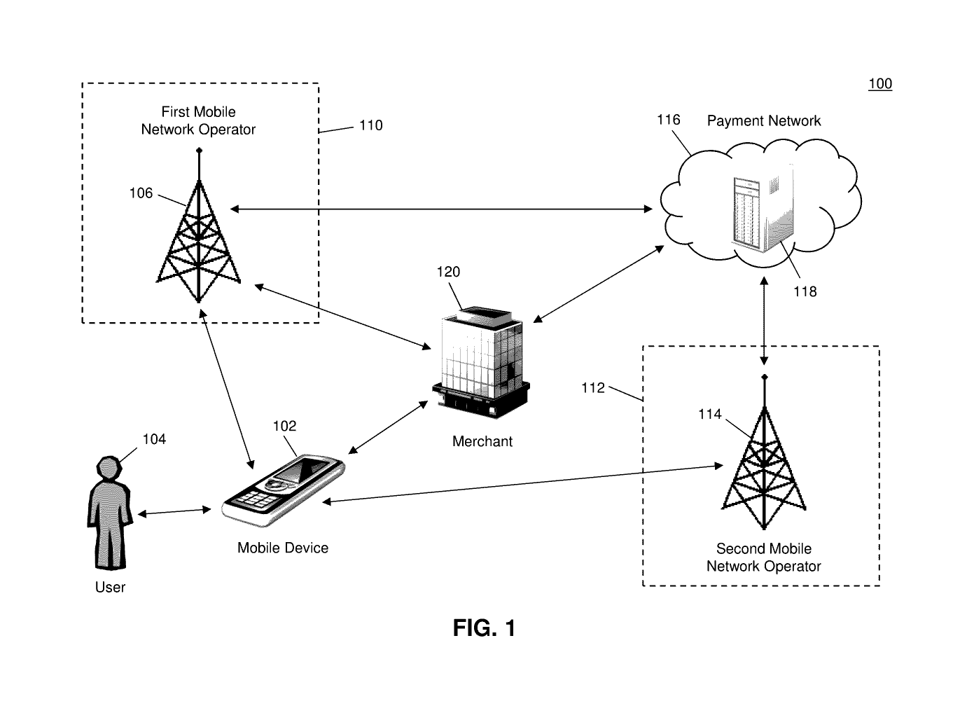

FIG. 1 illustrates a system 100 for sponsoring roaming on mobile devices by merchants.

The system 100 may include a mobile device 102. The mobile device 102 may be any type of mobile computing and/or communication device suitable for performing the functions disclosed herein as will be apparent to persons having skill in the relevant art, such as a cellular phone, smart phone, wearable computing device, laptop computer, tablet computer, notebook computer, smart watch, etc. A mobile device 102 may be operated by, in possession of, and/or otherwise associated with a user 104. The mobile device 102 may be associated with a first mobile network operator (MNO) 106. The first MNO 106, which may also be referred to herein as the home MNO, may provide the mobile device 102 with access to one or more networks (e.g., cellular networks, the Internet, local area networks, etc.) inside a first coverage area 110.

If the user 104 takes the mobile device 102 outside of the first coverage area 110, the first MNO 106 may no longer provide network access to the mobile device 102. In such instances, the user 104 may take the mobile device 102 into a second coverage area 112 that is operated by a second MNO 114. The second MNO 114 may also be referred to as a roaming MNO, and the associated second coverage 112 also referred to as a roaming area, as will be apparent to persons having skill in the relevant art.

In traditional systems, in order to access networks provided by the second MNO 114 in the second coverage area 112, the second MNO 114 may communicate with the first MNO 110 to identify if the mobile device 102 is to be allowed access. The first MNO 110 may prevent or allow access to other networks based on agreements with the user 104, company policy, rules and regulations, and other criteria and considerations. The first MNO 110 may provide the second MNO 114 with information regarding data accessibility by the mobile device 102 in the second coverage area 112, and the second MNO 114 may provide data to the mobile device 102 accordingly. For instance, the first MNO 110 may specify an amount or rate of data to be provided to the mobile device 102. The second MNO 114 may charge the first MNO 106 for data used by the mobile device 102, and the first MNO 106 may, in turn, pass the charges to the user 104 as per an established agreement.

In the systems and methods discussed herein, the system 100 may also include a payment network 116. The payment network 116 may include a processing server 118. The processing server 118, discussed in more detail below, may be configured to provide for sponsored roaming on the mobile device 102, whereby roaming fees and charges that are issued by the second MNO 114 for access to associated networks by the mobile device 102 are paid by a merchant 120.

The user 104 may, using the mobile device 102, submit a data usage request to the processing server 118, requesting data usage when in the second coverage area 112. The processing server 118 may forward a data request to an entity associated with control of data usage by the mobile device 102 in the second coverage area 112. The entity may be the second MNO 114, the first MNO 106, or may be a third party entity, such as an entity that controls data access on behalf of one or more MNOs. The entity may then open up data usage on the mobile device 102. In some instances, the data request may indicate the amount of data provided to the mobile device 102. In other instances, data usage may be activated for the mobile device 102 and then measured by the entity. In such instances, the entity may provide information regarding the data amount used by and/or provided to the mobile device 102 to the processing server 118.

The processing server 118 may be configured to calculate a transaction amount based on the data amount used by and/or provided to the mobile device 102 in the second coverage area 112. The transaction amount may be based on data usage rates, such as set by the second MNO 114 associated with the second coverage area 112 and/or the first MNO 106 associated with the mobile device 102. The processing server 118 may then initiate a payment transaction for payment of the transaction amount by the merchant 120, such that the merchant 120 sponsors the roaming data usage by the mobile device 102.

The merchant 120 may be identified by the processing server 118 using any suitable method as discussed herein. In one embodiment, the data request submitted by the user 104 using the mobile device 102 may indicate the merchant 120 that is to sponsor the roaming. In another embodiment, the merchant 120 may be identified based on the occurrence of a payment transaction involving the user 104 and the merchant 120 (e.g., using the mobile device 102), such as using the provided data. For example, the payment network 116 may receive an authorization request for a payment transaction initiated by the mobile device 102 and involving the merchant 120, with the merchant 120 being identified for payment of the associated roaming charges.

In another embodiment, the mobile device 102 may transmit data usage information to the processing server 118. The data usage information may include information identifying application programs executed by the mobile device 102 using the data provided to the mobile device 102 in the second coverage area 112, which may be used by the processing server 118 to identify one or more merchants 120 for payment of the transaction amount. For example, the user 104 may use an application program associated with the merchant 120 on their mobile device 102 with the provided data, and the associated costs of the data may be paid by the associated merchant 120.

In some embodiments, the payment by the merchant 120 may be paid to the second MNO 114 associated with the second coverage area 112. In other embodiments, the payment may be paid to the entity associated with the control of data usage by the mobile device 102. In yet another embodiment, the payment may be paid to the first MNO 106. In such an embodiment, the second MNO 114 or the entity associated with control of the data usage may first charge the first MNO 106 for the data, and the merchant 120 may pay the first MNO 106, such as for reimbursement of the roaming data charges. In some instances, the user 104 may pay for the roaming data charges, and the payment from the merchant 120 may be to the user 104, such as for reimbursement. In some embodiments, the processing server 118 may be configured to initiate multiple payment transactions. For instance, the processing server may initiate both a payment transaction from the first MNO 106 to the second MNO 114 for the transaction amount, and another payment transaction from the merchant 120 to the first MNO 106 for the transaction amount.

The methods and systems discussed herein may enable mobile devices 102 to be provided access to data outside of home network coverage areas that is sponsored by merchants, and thereby not paid for by the associated users or MNOs. This is an improvement over traditional systems, where such expenses are paid for either by the MNOs or by the end users 104, which may either limit the accessibility of users 104 to additional coverage areas, or may discourage users from using their mobile devices 102 in roaming areas. Traditional systems may also be unable to implement the methods discussed herein, as merchants 102 and MNOs may not be configured to communicate with one another, do to different protocols and communication standards. In addition, MNOs may transfer funds from one another using wire transfers or other methods, and may not be configured to initiate payment transactions due to the requirement of specialized standards and data formats for the generation and transmission of transaction messages. As a result, current technological systems may be incapable of performing the methods and systems discussed herein.

By performing the functions disclosed herein at a centralized processing server 118, the disclosed methods and systems may be implemented with minimal modification to existing merchant 120 and MNO systems. As a result, the methods and systems discussed herein may achieve a technological improvement whereby, using the mobile device 102, a user 104 may initiate the access of data in a second coverage area 112 outside of their home coverage area 110 that is sponsored by a merchant 120, relieving the user 104, first MNO 106, and second MNO 114 from absorbing costs of the roaming data usage in a manner that is not achievable using traditional systems.

### Processing Server

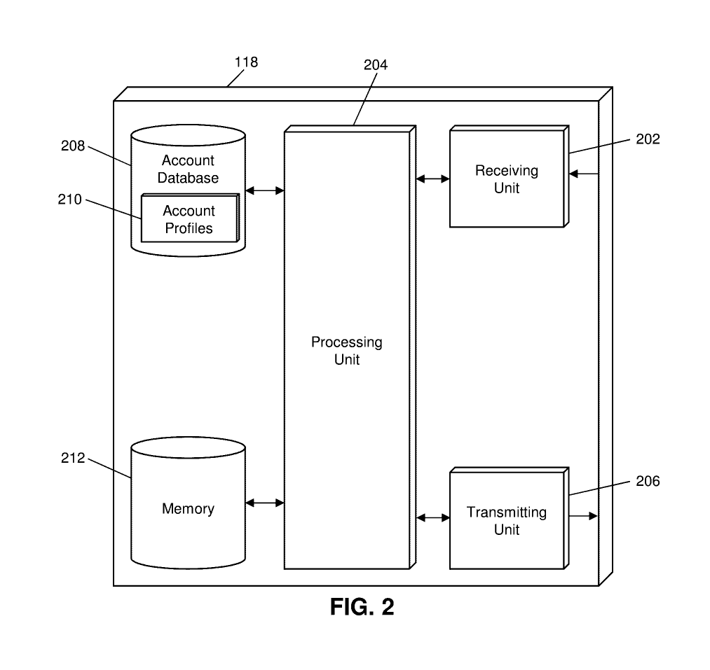

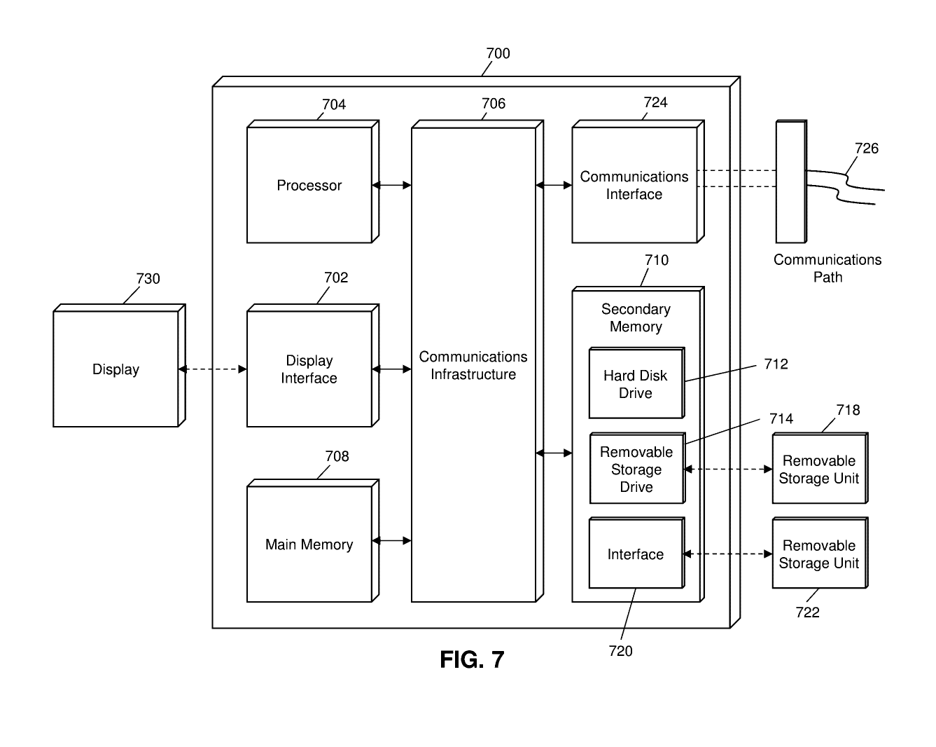

FIG. 2 illustrates an embodiment of the processing server 118 of the system 100. It will be apparent to persons having skill in the relevant art that the embodiment of the processing server 118 illustrated in FIG. 2 is provided as illustration only and may not be exhaustive to all possible configurations of the processing server 118 suitable for performing the functions as discussed herein. For example, the computer system 700 illustrated in FIG. 7 and discussed in more detail below may be a suitable configuration of the processing server 118.

The processing server 118 may include a receiving unit 202. The receiving unit 202 may be configured to receive data from one or more networks via one or more network protocols. For example, the receiving unit 202 may receive transaction messages from the payment network 116, may receive data requests from the mobile device 102 or from the first or second MNOs 106 and 114, may receive application data from the mobile device 102, may receive data usage information from the second MNO 114 or from an entity associated with data usage control on the mobile device 104, etc.

The processing server 118 may also include a processing unit 204. The processing unit 204 may be configured to perform the functions of the processing server 118 discussed herein that will be apparent to persons having skill in the relevant art. The processing unit 204 may be configured to generate a data request based on data included in a data usage request received by the receiving unit 202. For example, a data usage request may include a device identifier associated with a mobile device 102 from which the data usage request originates, and may also include at least a merchant identifier associated with the merchant 120. The processing unit 204 may be configured to identify an entity to which a data request is to be submitted and may generate a data request for usage of data by the mobile device 102 in the second coverage area 112. Identification of the entity may be based on data included in the data usage request, such as data indicating the entity or the second coverage area, geographic location data, or other suitable data that will be apparent to persons having skill in the relevant art.

The processing server 118 may also include a transmitting unit 206. The transmitting unit 206 may be configured to transmit data over one or more networks via one or more network protocols. The transmitting unit 206 may transmit data requests to entities associated with control of data usage by a mobile device 102 to request data usage on the mobile device 102 in the second coverage area 112.

The processing unit 204 may also be configured to generate authorization requests or other transaction messages for use in initiating and/or processing payment transactions. The processing unit 204 may also calculate transaction amounts for a payment transaction for the sponsoring of roaming by the mobile device 102. The transaction amounts may be based on data used by or otherwise provided to the mobile device 102, such as included in the data usage request or in data received by the receiving unit 202, as well as one or more rules or algorithms for calculating the transaction amount, such as associated with the second coverage area 112, first MNO 106, second MNO 114, third party entity, the payment network 116, or other entity. Once the transaction amount has been calculated or otherwise obtained (e.g., provided by the entity to which the data request was transmitted), the processing unit 204 may generate an authorization request for a payment transaction for payment of the transaction amount by the merchant 120. The authorization request may be generated and/or formatted pursuant to one or more standards associated with transaction messages, such as the ISO 8583 standard.

The transmitting unit 206 may be configured to transmit the authorization request to the payment network 116 for processing. In some embodiments, the transmitting unit 206 may transmit data to be included in an authorization request to the payment network 116 or other entity, for use in generating an authorization request. The transmitting unit 206 may be configured to transmit the authorization request or other data using one or more suitable methods and/or communication protocols associated with the transmission of financial data and/or transaction messages. For example, the transmitting unit 206 may be a specially configured transmission unit that can communicate with payment networks 116 and transmit transaction messages across payment rails. The processing server 118 and transmitting unit 206 may also be configured to initiate additional payment transactions, as discussed herein, such as for payments to/from the first MNO 106, the second MNO 114, the merchant 120, the entity associated with control of data usage of the mobile device 102, and any other suitable entity.

In some embodiments, the processing server 118 may also include an account database 208. The account database 208 may be configured to store a plurality of account profiles 210. Each account profile 210 may include data associated with an account, suitable for use in performing the methods and systems discussed herein. For example, in one embodiment, account profiles 210 may include data associated with transaction accounts. For instance, the account profiles 210 may be associated with transaction accounts associated with MNOs, such as the first MNO 106 and second MNO 112, for use in payments to and/or from the associated MNO. In some instances, account profiles 210 associated with MNOs may include amount rules, such as for calculating transaction amounts based on data usage, or other suitable data.

In another embodiment, account profiles 210 may include data associated with mobile devices 102. For instance, an account profile 210 associated with a mobile device 102 may include a device identifier associated with the mobile device 102, information identifying the first MNO 106 and/or the first coverage area 110 as the home MNO or home coverage area, and other suitable data, such as amount rules, data usage rules, merchant sponsoring rules, etc. The device identifier may be a unique value suitable for use in identifying the mobile device 102 and/or associated account profile 210, such as a telephone number, email address, media access control address, registration number, serial number, etc. The processing unit 204 may identify an account profile 210 using the device identifier included in a data usage request, which may be used to identify the first MNO 106 and/or the second MNO 114, for use in generating the data request and initiating the payment transaction for the sponsored roaming.

The processing server 118 may also include a memory 212. The memory 212 may be configured to store data suitable for use in performing the functions disclosed herein. For example, the memory 212 may be configured to store rules and/or algorithms for calculating transaction amounts, rules for identifying merchants 120, information suitable for identifying the second MNO 114 based on a second coverage area 112 and/or geographic location, rules for identifying an entity associated with control of data usage by the mobile device 102, rules for the generating of transaction messages, etc. Additional data that may be stored in the memory 212 will be apparent to persons having skill in the relevant art.

### Process for Sponsored Roaming for a Mobile Device

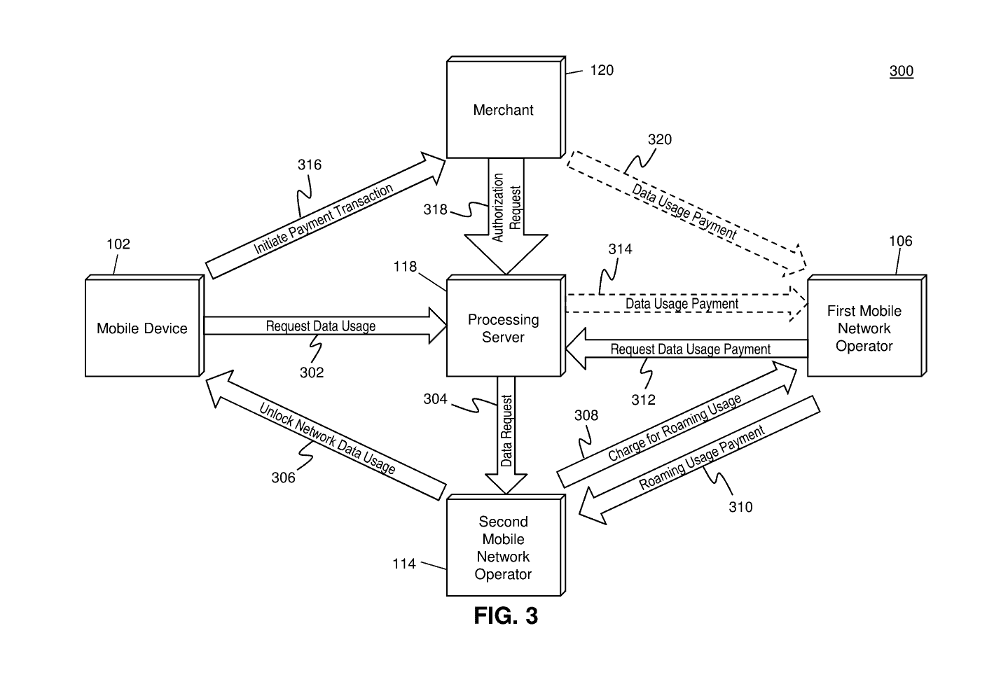

FIG. 3 illustrates a process 300 for the sponsoring of roaming for a mobile device 102 by a merchant 120 using the system 100 of FIG. 1.

In step 302, the mobile device 102 may submit a data usage request to the processing server 118. The data usage request may include a device identifier associated with the mobile device 102 and a merchant identifier associated with the merchant 120. In some embodiments, the data usage request may also include data identifying the second MNO 114 and/or the second coverage area 112, such as a geographic location or network identifier. In step 304, the processing server 118 may transmit a data request to the second MNO 114 that includes at least the device identifier. In some embodiments, the data request may also include a data amount, such as indicating an amount of rate of data to be provided to the mobile device 102 in the second coverage area 112. In some instances, the data request may be transmitted to an entity different from the second MNO 114 that is associated with control of data usage by the mobile device 102.

In step 306, the second MNO 114 may unlock data usage for the mobile device 102 in the second coverage area 112. In some instances, only specific networks and/or data communications may be enabled for the mobile device 102, such as based on the data usage request, criteria set by the second MNO 114, an agreement between the first MNO 106 and the second MNO 114, etc. In some instances, the second MNO 114 or other suitable entity may provide data to the mobile device 102 prior to receipt of the data request 304, such as data specifically for use by the mobile device 102 in submitting the data usage request to the processing server 118 in step 302. For example, the second MNO 114 may provide access for the mobile device 102 to one or more networks strictly for use of an application program used to submit data usage requests, prior to the unlocking of additional data usage in step 306.

In step 308, the second MNO 114 may charge the first MNO 106 for fees associated with the data usage provided to the mobile device 102. In some instances the fees may be based on data actually used by the mobile device 102. In other instances, the fees may be based on data available to the mobile device 102. In step 310, the first MNO 106 may provide payment to the second MNO 114 for the fees associated with the data usage. In some embodiments, steps 308 and 310 may be performed by the processing server 118 and/or the payment network 116, which may initiate and process a payment transaction for payment of the fees from the first MNO 106 to the second MNO 114.

In step 312, the first MNO 106 may request payment of the fees associated with the data usage from the processing server 118. The request may be received by the receiving unit 202 of the processing server 118, and the processing unit 204 may identify how payment is to be made. In some embodiments, the process 300 may proceed to step 314 where the processing server 118 may initiate payment for the data usage directly from the processing server 118 and/or the payment network 116 to the first MNO 106 for reimbursement of the fees. In some instances, the payment network 116 may have a transaction account associated with each MNO for use in reimbursing roaming fees and charges, such that the request submitted by the first MNO 106 in step 312 may be a payment request for the associated transaction account, which may result in easier processing and accounting for the payment network 116 and the first MNO 106. It will be apparent to persons having skill in the relevant art that step 314 may be an optional step.

In step 316, the mobile device 102 may initiate a payment transaction with the merchant 120, such as via a web browsing application program or an application program associated with the merchant 120 on the mobile device 102, using the data that had been provided to the mobile device 102 as a result of the submitted data usage request. As part of the payment transaction, the merchant 120 (e.g., or a financial institution acting on behalf of the merchant 120) may submit an authorization request for the payment transaction to the payment network 116. The authorization request and/or transaction data included therein may be forwarded to the processing server 118 and received by the receiving unit 202. The processing unit 204 may identify that the mobile device 102 involved in the transaction is the mobile device 102 for whom data usage was unlocked via the data usage request.

In some embodiments, the processing server 118 may then initiate a payment, in step 320, for the roaming fees from the merchant 120 to the first MNO 106. In such an embodiment, the merchant 120 may “sponsor” the roaming by reimbursing the first MNO 106 for the fees associated with the data usage provided to the mobile device 102, used to conduct a payment transaction involving the merchant 120. It will be apparent to persons having skill in the relevant art that step 320 may be an optional step. For instance, step 320 may not be performed if step 314 is performed where the first MNO 106 is reimbursed by the payment network 116. In such instances, step 320 may include payment of the reimbursement from the merchant 120 to the payment network 116.

It will be further apparent to persons having skill in the relevant art that, in some embodiments, the process 300 may include multiple merchants 120. For instance, steps 316, 318, and 320 may be performed for a plurality of merchants 120 with which the user 104 initiates payment transactions using the mobile device 102, using the data provided to the mobile device 102. In such an instance, each merchant 120 may pay a portion of the fees associated with the data usage. In some cases, the portions paid by each merchant 120 may be proportional to the amount of data used in association with the respective payment transaction. In such a case, the mobile device 102 may be configured to measure such data usage, which may be provided to the processing server 118.

### Processing Sponsored Roaming

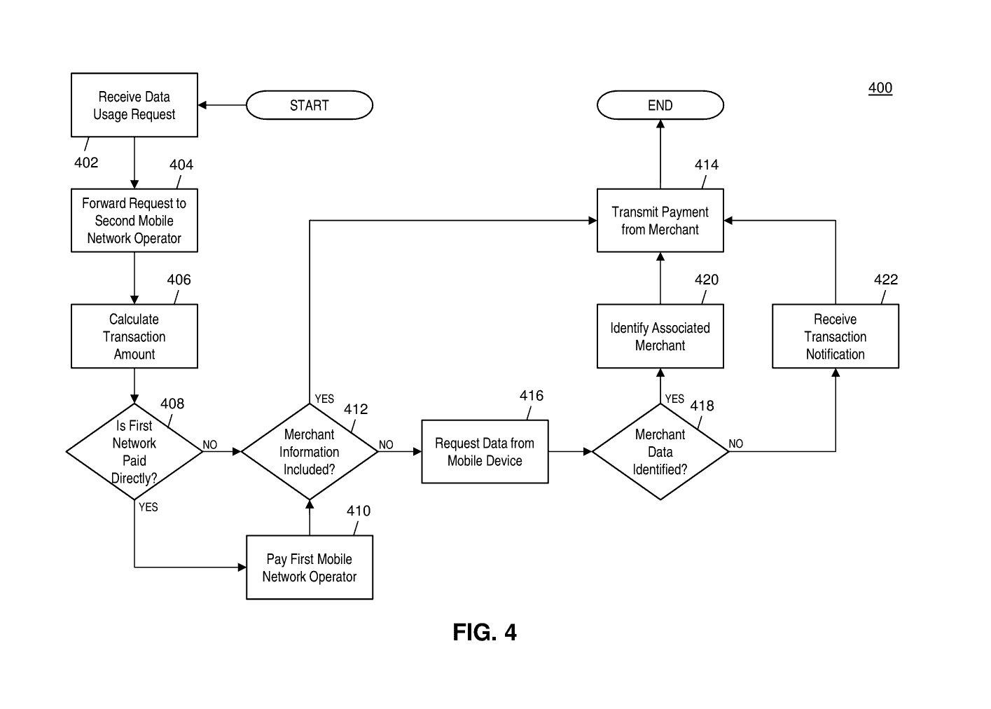

FIG. 4 illustrates a process 400 for the processing of sponsored roaming for the mobile device 102 by the processing server 118.

In step 402, the receiving unit 202 of the processing server 118 may receive a data usage request from the mobile device 102. The data usage request may be originate from a geographic location associated with the second MNO 114, such as a geographic location included in the second coverage area 112, and may include at least a device identifier associated with the mobile device 102. In some embodiments, the data usage request may also include a merchant identifier associated with a merchant 112.

In step 404, the transmitting unit 206 of the processing server 118 may transmit a data request to the second MNO 114. The transmitted data request may include at least the device identifier associated with the mobile device 102. In some embodiments, the data request may also include a data amount, such as one that may be included in the received data usage request. In step 406, the processing unit 204 of the processing server 118 may calculate a transaction amount. The transaction amount may be calculated based on the data amount made available to the mobile device 102 or actually used by the mobile device 102, which may be received by the receiving unit 202 from the second MNO 114, or may be identified in the received data usage request. The transaction amount may also be based on one or more rules or algorithms suitable for the calculation thereof, which may be dependent on the second MNO 114, the mobile device 102, a first MNO 106 associated with the mobile device 102, or other suitable criteria.

In step 408, the processing unit 204 may determine if the first MNO 106 is to be paid directly by the payment network 116 for roaming fees that may be assessed on the first MNO 106 by the second MNO 114. If the first MNO 106 is to be paid directly, then, in step 410, the processing unit 204 may initiate a payment transaction for payment of the calculated transaction amount to the first MNO 106, such as from a transaction account associated with the first MNO 106. It will be apparent to persons having skill in the relevant art that, in step 408 and 410, the first MNO 106 may be substituted for the second MNO 114, such as in instances where the second MNO 114 does not charge the first MNO 106 for the data usage, or substituted for a third party entity, such as one associated with the control of data usage by the mobile device 102 in the second coverage area 112.

In step 412, the processing unit 204 may determine if information identifying the merchant 120 that is sponsoring the roaming was provided in the received data usage request. If the merchant 120 was identified, then, in step 414, the processing unit 204 may initiate payment from the merchant 120. Payment from the merchant 120 may be made to the first MNO 106 if the determination in step 408 was that the first MNO 106 was not paid directly, or may be paid to the payment network 116 if, in step 410, the payment network 116 paid the first MNO 106. It will be apparent to persons having skill in the relevant art that the payment from the merchant 120 may be to the second MNO 114 or other entity in appropriate instances if applicable.

If, in step 412, the processing unit 204 determines that the merchant 120 had not been identified, then, in step 416, the transmitting unit 206 may transmit a request for data from the mobile device 102. The mobile device 102 may return data to the processing server 118, to be received by the receiving unit 202, if available, regarding the sponsoring of the roaming data usage. In step 418, the processing unit 204 may determine if such data was identified by the mobile device 102. For example, data may be identified by the mobile device 102 if the mobile device 102 identified application programs executed by the mobile device 102 using the provided roaming data associated with merchants 120 that may sponsor roaming.

If the mobile device 102 provided data suitable for identifying merchants 120, then, in step 420, the processing unit 204 may identify the associated merchant 120 or merchants 120. In some instances, the merchant(s) 120 may be directly identified in the information provided by the mobile device 102. In other instances, the processing unit 204 may be configured to determine the associated merchant(s) 120, such as based on program data, using lookup tables, or other suitable methods that will be apparent to persons having skill in the relevant art. If the mobile device 102 did not provide data suitable for identifying merchants 120, then, in step 422, the processing server 118 may wait until the receiving unit 202 receives a notification of a payment transaction involving the mobile device 102 and a merchant 120. The merchant 120 involved in the payment transaction may then be identified by the processing unit 204, such as based on a merchant identifier or associated transaction account identifier included in the transaction notification.

Once the merchant has been identified, either via the transaction notification or the information provided by the mobile device 102, then the process 400 may proceed to step 414 where the processing unit 204 initiates payment from the identified merchant 120. As discussed above, the payment may be initiated from the merchant 120 to the first MNO 106, the second MNO 114, the third party entity, or to the payment network 116, based on the determination made in step 408. In some embodiments, step 414 may be repeated for each merchant 120 identified in steps 412, 420, and/or 422.

### Graphical User Interface

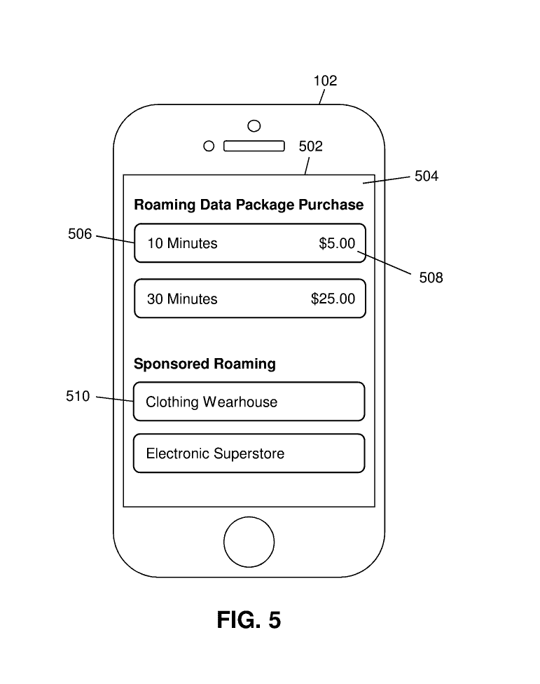

FIG. 5 illustrates an exemplary graphical user interface of the mobile device 102 for submitting a data usage request to the processing server 118, such as illustrated in steps 302 and 402 of FIGS. 3 and 4, respectively, and discussed above. It will be apparent to persons having skill in the relevant art that the graphic user interface illustrated in FIG. 5 and discussed herein is provided as an illustration only, and that additional interfaces and configurations may be used in conjunction with the methods and systems discussed herein for providing sponsored roaming to mobile devices 120.

As illustrated in FIG. 5, the mobile device 102 may include a display unit 502. The display unit 502 may be configured to display data to the user 104 of the mobile device 102. The display unit 502 may be any suitable type of display unit, such as a touch screen display, liquid crystal display, light emitting diode display, thin film transistor display, etc. The display unit 502 may display a data usage request screen 504. The data usage request screen 504 may be displayed via execution of a specially configured application program by the mobile device 102, via navigation to a specially programmed web page by a web browser, or other suitable method.

The data usage request screen 504 may include a plurality of data amounts 506. Each data amount 506 may include a value corresponding to a volume or rate of data that is requested for use by the mobile device 102 in the second coverage area 112. In some instances, one or more data amounts 506 may serve as a limit on data usage, but with the associated charges being based on actual data used by the mobile device 102. In such instances, the attribute may be identified in the data usage request screen 504. Each data amount 506 may also include a purchase amount 508. The purchase amount 508 may be the transaction amount calculated by the processing server 118 or equivalent thereof, and may represent the fees charged by the second MNO 114 or entity associated with the control of data usage in the second coverage area 112 for the usage of data by the mobile device 102. In some instances, the purchase amount 508 may be based on actual data used, and/or may be representative of use of the maximum data usable by the mobile device 102, and may not be charged unless the full data amount 506 is used.

The data usage request screen 504 may also include merchant selections 510. Each merchant selection 510 may correspond to a merchant 120 that may sponsor the roaming. The selection of a merchant 120 using the merchant selection 510 may include a merchant identifier associated with the corresponding merchant 120 in the data usage request that is submitted to the processing server 118, for use in processing the sponsored roaming payment. In some instances, the data usage request screen 504 may enable the user 102 to select both a data amount 506 and a merchant selection 510. In other instances, a user 102 may select only one. For example, if the user 102 selects only a data amount 506, then the processing server 118 may later identify a merchant 120 for charging of the roaming fees, such as based on a transaction or application data provided by the mobile device 102. In another example, if the user 102 selects only a merchant selection 510, the corresponding merchant 120 may be charged for the actual data used by the mobile device 102.

### Exemplary Method for Providing Sponsored Roaming for a Mobile Device

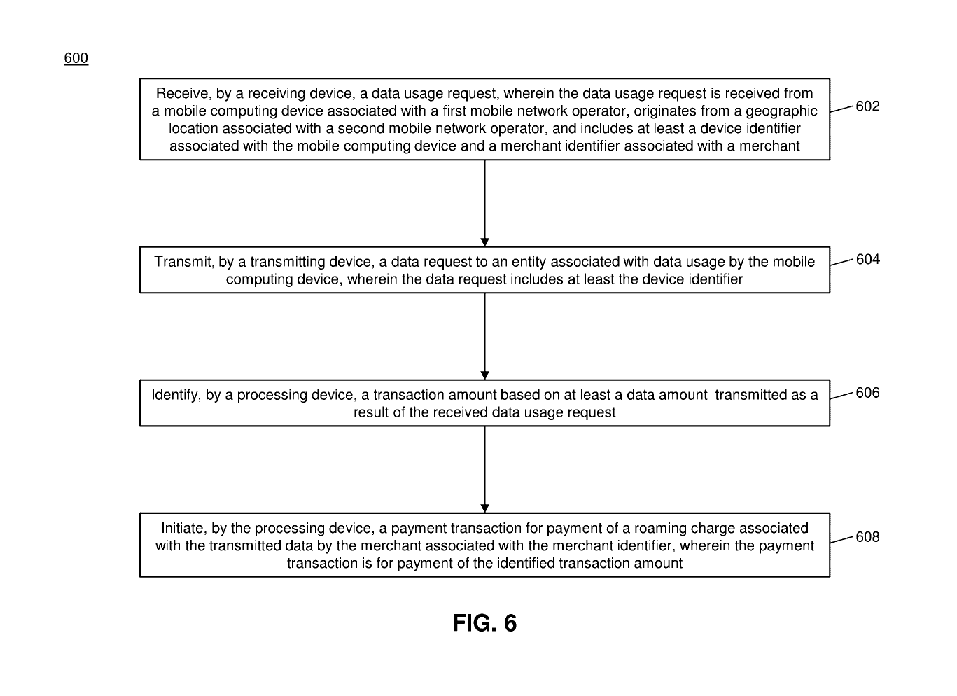

FIG. 6 illustrates a method 600 for providing sponsored roaming for a mobile device in a geographic location outside of home network coverage that is sponsored by a merchant.

In step 602, a data usage request may be received by a receiving device (e.g., the receiving unit 202), wherein the data usage request is received from a mobile computing device (e.g., the mobile device 102) associated with a first mobile network operator (MNO) (e.g., the first MNO 106), originates from a geographic location associated with a second MNO (e.g., the second MNO 114), and includes at least a device identifier associated with the mobile computing device 102 and a merchant identifier associated with a merchant (e.g., the merchant 120). In one embodiment, the geographic location may be included in a geographic area not serviced by the first MNO 106. In some embodiments, the device identifier may be at least one of: a media access control address, a phone number, a serial number, a registration number, and an identification number.

In step 604, a data request may be transmitted by a transmitting device (e.g., the transmitting unit 206) to an entity associated with data usage by the mobile computing device 102, wherein the data request includes at least the device identifier. In some embodiments, the entity associated with control of data usage by the mobile computing device 102 may be one of: the first MNO 106 and the second MNO 114. In step 606, a transaction amount may be identified by a processing device (e.g., the processing unit 204) based on at least a data amount transmitted as a result of the received data usage request.

In step 608, a payment transaction may be initiated by the processing device 204 for payment of a roaming charge associated with the transmitted data by the merchant 120 associated with the merchant identifier, wherein the payment transaction may be for payment of the identified transaction amount. In one embodiment, the payment transaction may be a single payment transaction for payment of the identified transaction amount from the merchant 120 associated with the merchant identifier to the first MNO 106 or the second MNO 114. In another embodiment, the payment transaction may be a first payment transaction for payment of the identified transaction amount from the merchant 120 associated with the merchant identifier to a third party, and where the method 600 further includes initiating, by the processing device 204, a second payment transaction for payment of the identified transaction amount to the first MNO 104 or the second MNO 116 from the third party.

In some embodiments, the method 600 may also include: receiving, by the receiving device 202, transaction data for a payment transaction involving a consumer (e.g., the user 104) associated with the mobile computing device 102, wherein the transaction data includes at least the merchant identifier; and identifying, by the processing device, the merchant 120 based on the merchant identifier included in the received transaction data. In one embodiment, the method 600 may further include: storing, in a memory (e.g., the memory 212), a plurality of amount rules, wherein each amount rule is associated with at least one MNO; and identifying, by the processing device 204, a specific amount rule in the memory associated with the first MNO 106, wherein the transaction amount is identified based on application of the identified specific amount rule to a data amount included in the received data usage request.

In some embodiments, the method 600 may also include: receiving, by the receiving device 202, usage data from the mobile computing device 102, wherein the usage data includes one or more application programs executed by the mobile computing device 102 subsequent to a submission of the data usage request; and identifying, by the processing device 204, the merchant 120 as being associated with one of the one or more application programs included in the received usage data. In one embodiment, the method 600 may further include processing, by the processing device 204, a payment transaction for payment from the first MNO 106 to the second MNO 114.

### Computer System Architecture

FIG. 7 illustrates a computer system 700 in which embodiments of the present disclosure, or portions thereof, may be implemented as computer-readable code. For example, the processing server 118 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for providing sponsored roaming for mobile devices. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing sponsored roaming for a mobile device, comprising:
receiving, by a receiving device, a data usage request, wherein the data usage request is received from a mobile computing device associated with a first mobile network operator, originates from a geographic location associated with a second mobile network operator, and includes at least a device identifier associated with the mobile computing device and a merchant identifier associated with a merchant;
transmitting, by a transmitting device, a data request to an entity associated with control of data usage by the mobile computing device, wherein the data request includes at least the device identifier;
identifying, by a processing device, a transaction amount based on at least a data amount transmitted as a result of the received data usage request; and
initiating, by the processing device, a payment transaction for payment of a roaming charge associated with the transmitted data by the merchant associated with the merchant identifier, wherein the payment transaction is for payment of the identified transaction amount.

2. The method of claim 1, wherein the payment transaction is a single payment transaction for payment of the identified transaction amount from the merchant associated with the merchant identifier to the first mobile network operator or second mobile network operator.

3. The method of claim 1, wherein the payment transaction is a first payment transaction for payment of the identified transaction amount from the merchant associated with the merchant identifier to a third party, and wherein the method further comprises:
initiating, by the processing device, a second payment transaction for payment of the identified transaction amount to the first mobile network operator or the second mobile network operator from the third party.

4. The method of claim 1, further comprising:
receiving, by the receiving device, transaction data for a payment transaction involving a consumer associated with the mobile computing device, wherein the transaction data includes at least the merchant identifier; and
identifying, by the processing device, the merchant based on the merchant identifier included in the received transaction data.

5. The method of claim 1, further comprising:
storing, in a memory, a plurality of amount rules, wherein each amount rule is associated with at least one mobile network operator; and
identifying, by the processing device, a specific amount rule in the memory associated with the first mobile network operator, wherein
the transaction amount is identified based on application of the identified specific amount rule to a data amount included in the received data usage request.

6. The method of claim 1, wherein the geographic location is included in a geographic area not serviced by the first mobile network operator.

7. The method of claim 1, wherein the entity associated with control of data usage by the mobile computing device is one of: the first mobile network operator and the second mobile network operator.

8. The method of claim 1, further comprising:
processing, by the processing device, a payment transaction for payment from the first mobile network operator to the second mobile network operator.

9. The method of claim 1, further comprising:
receiving, by the receiving device, usage data from the mobile computing device, wherein the usage data includes one or more application programs executed by the mobile computing device subsequent to a submission of the data usage request; and
identifying, by the processing device, the merchant as being associated with one of the one or more application programs included in the received usage data.

10. The method of claim 1, wherein the device identifier is at least one of: a media access control address, a phone number, a serial number, a registration number, and an identification number.

11. A system for providing sponsored roaming for a mobile device, comprising:
a receiving device configured to receive a data usage request, wherein the data usage request is received from a mobile computing device associated with a first mobile network operator, originates from a geographic location associated with a second mobile network operator, and includes at least a device identifier associated with the mobile computing device and a merchant identifier associated with a merchant;
a transmitting device configured to transmit a data request to an entity associated with control of data usage by the mobile computing device, wherein the data request includes at least the device identifier; and
a processing device configured to
identify a transaction amount based on at least a data amount transmitted as a result of the received data usage request, and
initiate a payment transaction for payment of a roaming charge associated with the transmitted data by the merchant associated with the merchant identifier, wherein the payment transaction is for payment of the identified transaction amount.

12. The system of claim 11, wherein the payment transaction is a single payment transaction for payment of the identified transaction amount from the merchant associated with the merchant identifier to the first mobile network operator or second mobile network operator.

13. The system of claim 11, wherein
the payment transaction is a first payment transaction for payment of the identified transaction amount from the merchant associated with the merchant identifier to a third party, and
the processing device is further configured to initiate a second payment transaction for payment of the identified transaction amount to the first mobile network operator or the second mobile network operator from the third party.

14. The system of claim 11, wherein
the receiving device is further configured to receive transaction data for a payment transaction involving a consumer associated with the mobile computing device, wherein the transaction data includes at least the merchant identifier; and
the processing device is further configured to identify the merchant based on the merchant identifier included in the received transaction data.

15. The system of claim 11, further comprising:
a memory configured to store a plurality of amount rules, wherein each amount rule is associated with at least one mobile network operator; wherein
the processing device is further configured to identify a specific amount rule in the memory associated with the first mobile network operator, and
the transaction amount is identified based on application of the identified specific amount rule to a data amount included in the received data usage request.

16. The system of claim 11, wherein the geographic location is included in a geographic area not serviced by the first mobile network operator.

17. The system of claim 11, wherein the entity associated with control of data usage by the mobile computing device is one of: the first mobile network operator and the second mobile network operator.

18. The system of claim 11, wherein the processing device is further configured to process a payment transaction for payment from the first mobile network operator to the second mobile network operator.

19. The system of claim 11, wherein
the receiving device is further configured to receive usage data from the mobile computing device, wherein the usage data includes one or more application programs executed by the mobile computing device subsequent to a submission of the data usage request, and
the processing device is further configured to identify the merchant as being associated with one of the one or more application programs included in the received usage data.

20. The system of claim 11, wherein the device identifier is at least one of: a media access control address, a phone number, a serial number, a registration number, and an identification number.
